(19) United States
(12) Patent Application Publication
(10) Pub. No.: US 2012/0007320 A1
(43) Pub. Date: Jan. 12, 2012

(54) Connector gasket for concrete structures

(76) Inventors: Bradford G. Corbett, JR., Fort Worth, TX (US); Randall Chinchilla, San Jose (CR); Bernal Lopez, Heredia (CR)

(21) Appl. No.: 13/199,473

(22) Filed: Aug. 31, 2011

Related U.S. Application Data
(62) Division of application No. 12/112,585, filed on Apr. 30, 2008.
Application No. 12/112,585 is a continuation-in-part of application No. 11/220,052, filed on Sep. 6, 2005, now Pat. No. 7,392,989.
(60) Provisional application No. 60/607,616, filed on Sep. 7, 2004.

(51) Int. Cl. F16L 5/10

(52) U.S. Cl. 277/606

(57) ABSTRACT

A manhole assembly for a manhole having generally cylindrical sidewalls defined between an outside surface and an inside surface separated by a wall thickness and having a wall opening communicating the outside and inside sidewall surfaces of the manhole for insertion of a mating pipe. The wall opening defines a peripheral surface relatively perpendicular to the outside and inside sidewall surfaces which receives a ring shaped elastomeric gasket. The gasket has one or more retaining rings which are encapsulated within the material of the gasket body and which allow the gasket to be obliquely inserted within the wall opening of the manhole and to be subsequently snap-fitted into position on the peripheral surface, whereby the gasket is securely retained in a locked-in position with respect to the wall opening in the sidewall of the manhole.

### 1. CROSS-REFERENCE TO RELATED APPLICATION

The present application is a divisional of earlier filed application Ser. No. 12/112,585, filed Apr. 30, 2008, entitled “Connector Gasket for Concrete Structures”, by Bradford G. Corbett, Jr., Randall Chinchilla and Bernal Lopez, which was a continuation-in-part from an earlier filed application Ser. No. 11/220,052, filed Sep. 6, 2005, entitled “Connector Gasket for Concrete Structures,” by Bradford G. Corbett, Jr., now issued U.S. Pat. No. 7,392,989, issued Jul. 1, 2008, which claims priority from provisional Ser. No. 60/607,616, filed Sep. 7, 2004, entitled “Connector Gasket For Concrete Structures”, by Bradford G. Corbett, Jr.

### 2. FIELD OF THE INVENTION

The present invention relates generally to the installation of sanitary sewers and more specifically, to the problem of tightly sealing a manhole against inflow or outflow of liquid at the point where a sewer pipe passes through its walls and still more specifically to elastomeric gaskets for resiliently supporting and sealing the space between a pipe and the surrounding surface of an opening in the manhole through which the pipe passes.

### 3. DESCRIPTION OF THE RELATED ART

Pipes are commonly used for the conveyance of fluids in a variety of municipal applications, including their use as free-flowing conduits running partly full, as in drains and sewers. Pipes used in these type applications have been made of steel, cast iron, concrete, vitrified clay, and most recently, plastic including the various polyolefins and PVC.

In sewer lines, manholes are ordinarily installed at various intervals including locations where the sewer line changes elevation or direction. Manholes are typically formed in molds from a settable material such as concrete. The mold may form one or more annular openings in the manhole in which sewer pipes are positioned to lie adjacent a wall of the manhole defining that particular opening. The joint between the manhole wall and outer surface of the sewer pipe is sealed to prevent ground water from entering the manhole and to prevent contents of the manhole, such as sewage and water, from leaking out of the manhole. When ground water enters the manhole, it often brings in sediment which collects in the sewer over time. Such sediment causes clogs and inhibits the ability of the manhole to carry water. In addition, infiltration of ground water also increases the total volume of sewage flow through sewer lines which increases the required size of pipe needed as well as the expense of treatment of the total sewage flow. When the contents of the manhole leak, they can pollute the ground water.

Various types of gaskets for sealing joints between pipes and manholes are known. Often these gaskets are formed from an elastomeric material that is either inserted in an opening in the manhole and expanded via a ring or physically embedded in a portion of a wall adjacent the opening in the manhole. It is generally necessary to either physically embed the gasket in the concrete wall of the manhole or to use some type of physical expansion mechanism in order to insure that the gasket is properly retained in the desired position as the mating male pipe end is inserted into the manhole opening.

Expanded gaskets require rings that exert an outwardly, radially directed force on an inner surface of a gasket positioned within the opening to compress the gasket against a manhole wall defining the opening. These rings increase both material and labor installation costs associated with sealing the joint between the manhole wall and pipe. Material costs are increased because these rings are somewhat complicated corrosion-resistant metal structures that must be manually fabricated or are molded plastic structures that are made, at least in part, from high strength, expensive compositions. Labor costs are increased because installation and expansion of such rings to effect a seal requires maintaining proper alignment of the ring and use of equipment such as mechanical expansion units. In addition, seal failure will occur if the rings are improperly installed.

Embedded gaskets solve certain of the problems associated with the manufacture and installation of expansion gaskets. Embedded gaskets also allow a larger diameter of pipe to be inserted into an opening in a manhole than expanded gaskets because a separate ring is unnecessary. As is known, outside pipe diameter size can increase up to a certain point at which an expanded gasket can no longer be used for a particular sized manhole because the width of a wall defining an opening in the manhole will no longer be large enough to support the expansion ring. This means that a next, larger sized, more expensive manhole must be used for the larger diameter pipe.

A disadvantage of embedded gaskets, on the other hand, is that a portion of the gasket body must be set in the wall of the manhole defining the opening for the mating male pipe. This introduces extra complexity into the manhole molding process. Another problem which can occur with embedded gaskets is that parts of the gasket can, on occasion, roll and shift as the pipe is being inserted. This rolling and shifting of the embedded gasket can weaken the actual manhole material itself and in turn adversely affect the ultimate sealing capacity of the joint.

What is needed is a gasket design which achieves the advantages of the embedded gasket but which will not tend to roll and shift as the pipe is being inserted within a manhole opening.

Also needed is such an improved gasket design which achieves these performance results without the need for external expansion rings or separate components to achieve ring expansion.

A need also exists for an improved sealing system of the above type which does not involve an embedded gasket portion of the type which would add extra complexity to the manhole molding process.

### SUMMARY OF THE INVENTION

It is an object of the present invention to provide an integrated manhole connection including a sealing gasket that will not tend to roll and shift as a mating pipe is being inserted within an opening in the manhole and which will not tend to be displaced from its sealing position due to a difference of internal or external pressures on either side of the sealing connection.

Another object of the present invention is to provide such an improved gasket design which achieves these performance results without the need for external expansion rings or other separate mechanical components to achieve ring expansion.

A further object of the invention is to provide such an improved sealing system of the above type which does not involve an embedded gasket portion of the type which would add extra complexity to the manhole molding process.

The above objects are achieved by providing an improved manhole connection for a precast manhole having a wall thickness and a wall opening defining a peripheral surface which is perpendicular to the external sidewalls of the manhole. A ring shaped elastomeric body is received within the wall opening in snap-fit fashion. The ring shaped elastomeric body carries at least one relatively rigid ring which circumscribes the gasket body. The location of the ring is precisely determined to allow the gasket to be obliquely inserted within the wall opening of the manhole and to be subsequently snap-fitted into position, whereby the gasket is securely retained in a locked-in position with respect to the wall opening in the sidewall of the manhole. If only one rigid ring is present, it is generally encapsulated in the material of the elastomeric gasket body and is snap-fit within a mating groove or depression provided in the wall opening. Where more than one rigid ring is present, the rings may straddle the wall opening in the sidewall of the manhole opening. A third ring, or additional number of rings, may also be present to more securely engage an external surface of the mating male pipe being inserted into the wall opening of the manhole.

In one version of the connector system of the invention, a ring shaped elastomeric gasket is provided which has a central circumferential sealing region of substantially rectangular cross section. The central sealing region has a pair of oppositely extending flap regions each of which terminates in an outer peripheral region which contains at least one embedded retaining ring. The central circumferential sealing region has opposing sealing surfaces, one of which seals against the internal diameter of the concrete manhole and, the other of which seals against the external surface of the mating pipe. The flap regions are defined by substantially planar opposing faces which extend outwardly from approximately mid-region from the central circumferential sealing region.

In another version of the connector system of the invention, a ring shaped elastomeric gasket is provided having a body formed of rubber retained in position on the peripheral surface of the wall opening in the manhold. The ring shaped elastomeric gasket has a substantially homogeneous composition and has at least a pair of relatively rigid retaining rings embedded within the rubber of the gasket body. In the preferred form, the ring shaped elastomeric gasket body is a truncated cone shape with a cylindrical upper portion and a flared base and oppositely arranged upper and lower peripheries, the upper periphery of the upper portion contains one relatively rigid retaining ring and the lower periphery of the lower flared portion contains another of the other relatively rigid retaining ring, the retaining rings being completely encapsulated within the elastomeric gasket body. The relatively rigid retaining ring contained in the upper periphery of the upper portion forms a fluid tight seal between the manhole and the mating pipe. The relatively rigid retaining ring contained in the lower periphery of the lower flared portion serves as a sealing gasket for the opening in the manhole, whereby the gasket is securely retained in a locked-in position with respect to the wall opening in the sidewall of the manhole.

Additional objects, features and advantages will be apparent in the written description which follows.

### BRIEF DESCRIPTION OF THE DRAWINGS

FIG. 1 is a perspective view of a manhole with parts broken away and showing a mating pipe used to form a manhole connection;

FIG. 1A is a perspective view similar to FIG. 1 but with the mating pipe removed to better illustrate the manhole opening;

FIG. 2 is an isolated view of one version of the sealing gasket used in the manhole connection of the invention;

FIG. 3 is an isolated, cross sectional view of the sealing gasket of FIG. 2 being received in snap-fit fashion within a mating groove or depression provided in the wall thickness of the manhole opening;

FIG. 3A is a view similar to FIG. 3 but showing a mating pipe used to form a sealed manhole connection;

FIG. 4 is an isolated, cross sectional view, similar to FIG. 3, but showing another version of the sealing gasket of the invention, in this case having two rigid rings which straddle the wall opening in the manhole;

FIG. 4A is a view similar to FIG. 4, but showing a mating pipe used to form a sealed manhole connection;

FIG. 5 is a view similar to FIG. 4, but showing another version of the gasket of the invention in which a third rigid ring is used to form a more secure seal with an external surface of the mating male pipe, a portion of the male pipe being shown in phantom lines;

FIG. 6 is a cross sectional view, similar to FIG. 3A, but showing another version of the sealing gasket of the invention, in this case having a central circumferential sealing region and a pair of oppositely extending flap regions with a pair of encapsulated retaining rings that straddle the wall opening in the manhole;

FIG. 6A is a view similar to FIG. 6, but showing the sealing gasket receiving the mating male pipe;

FIG. 7 is a perspective view of another version of the manhole connector of the invention with parts broken away and showing three encapsulated rings, one of the rings being encapsulated within the upper cylindrical portion of the connector and the other two rings being encapsulated within the lower portion of the flared base;

FIG. 8 is a perspective view of the manhole connector of FIG. 7.

FIG. 9 is a perspective view, similar to FIG. 1, but showing the manhole connector of FIG. 7 installed in a manhole, with parts of the manhole broken away and showing a mating pipe used to form a manhole connection.

### DETAILED DESCRIPTION OF THE PREFERRED EMBODIMENT

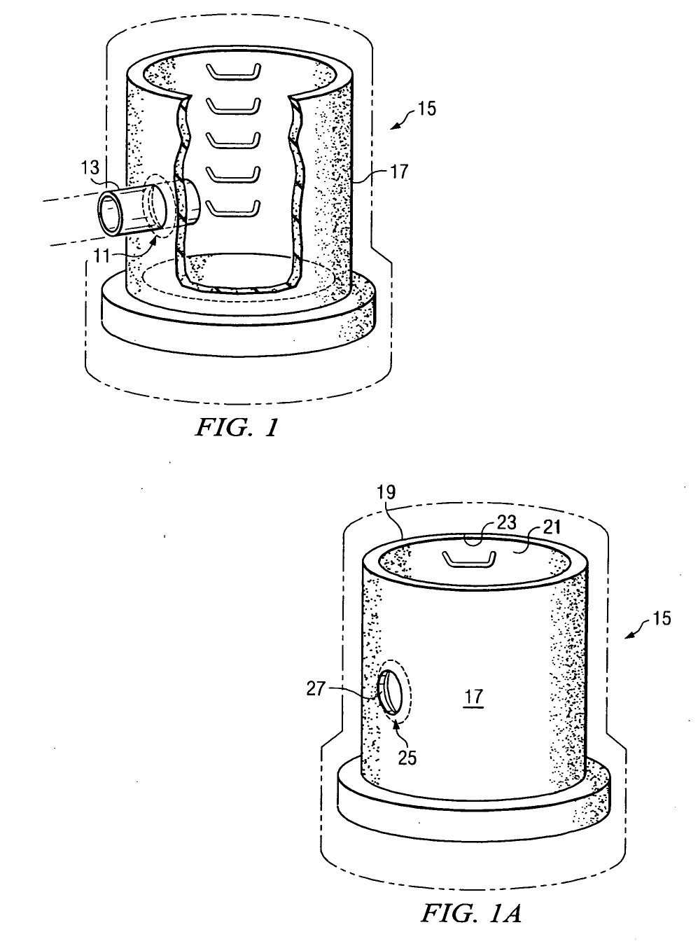

Turning first to FIGS. 1 and 1A, there is shown a manhole connection, designated generally as 11, provided for connecting a sewer pipe or insertion pipe 13 to a manhole 15. The manhole 15 is formed of a cast, settable material. Preferably, the manhole 15 is made of concrete but may be made of vitrified clay or other similar castable materials and is generally cylindrical in shape and typically about 3-5 feet in diameter and about 3 feet high. Generally the manhole 15 is sufficiently large enough to accommodate a person working therein.

The manhole 15 has generally symmetrical, cylindrical sidewalls 17 defined by an outside surface 19 and an inside surface 21 separated by a wall thickness 23. The wall thickness 23 can vary but is generally less than about 12 inches. An opening 25 in the manhole sidewall 17 is provided that communicates the outside surface 19 and inside surface 21 of the manhole 15 for insertion of the mating pipe 13. The opening 25 is bounded by a peripheral surface 27 which is generally perpendicular to the outside surface 110 of the sidewalls 17 of the manhole 104. The peripheral surface 27 has a thickness which is typically the same thickness as that of the sidewall 17 but can be less than the entire wall thickness which, in this case, is about 12 inches.

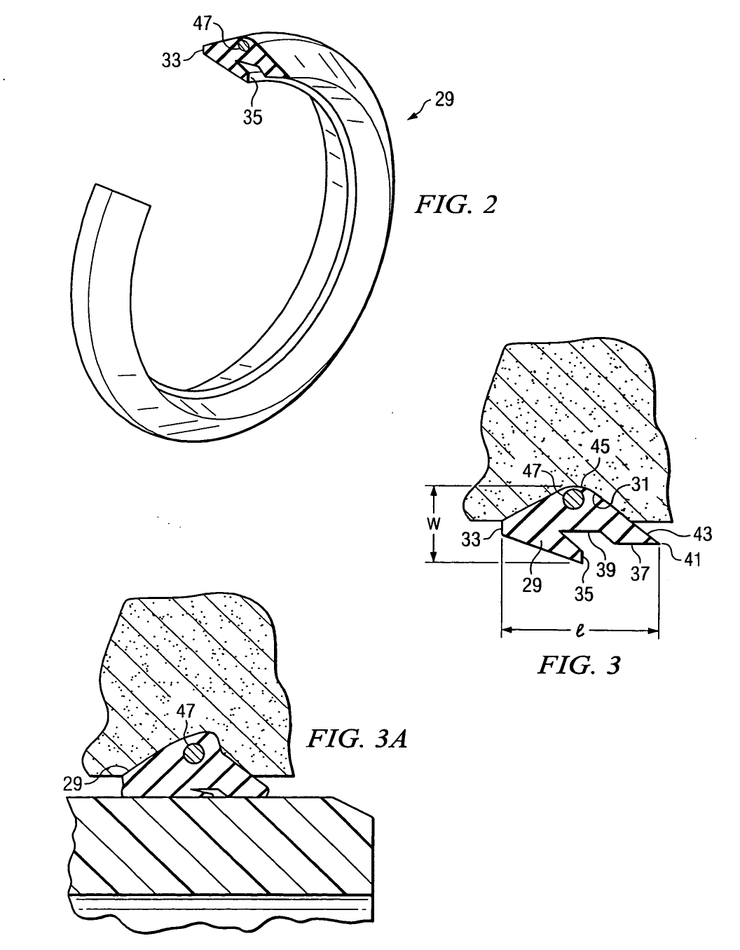

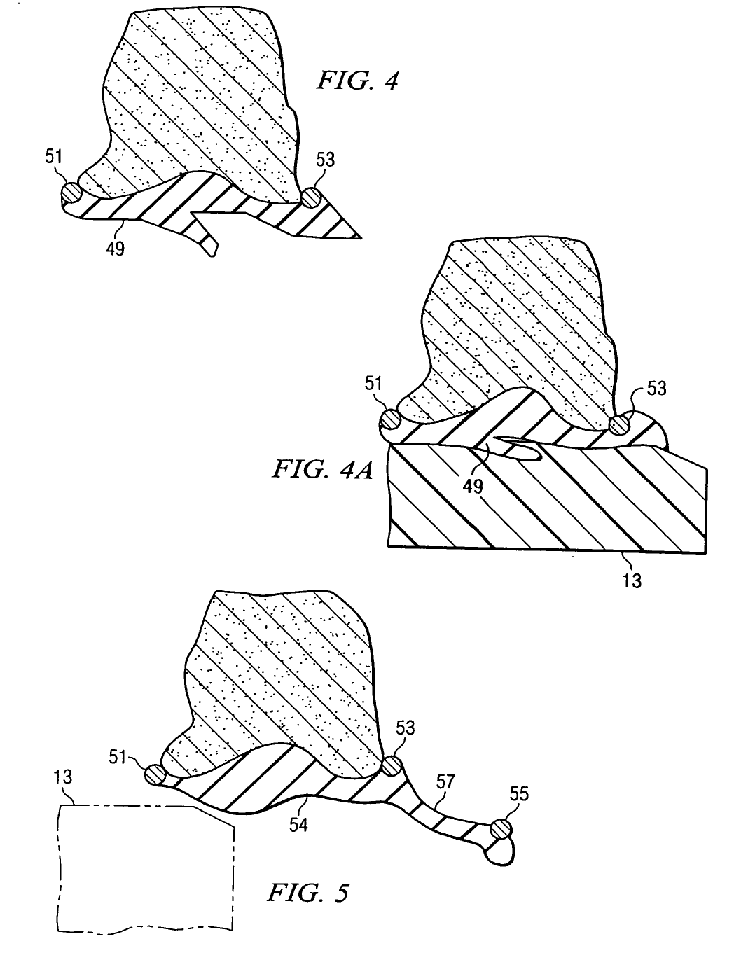

A ring shaped elastomeric body gasket body (29 in FIGS. 2-3A) is provided in order to form a fluid seal between the pipe 13 and the opening 25 in the manhole sidewall 17 in order to prevent water or sewage charged into the manhole 15 from leaking outwardly past the pipe 13 and to prevent ground water from leaking into the inside of the manhole 15. Also, the elastomeric gasket body 29 is provided in order to afford a small degree of freedom of movement between the pipe 13 and the manhole 15 to compensate for misalignment which occurs during installation or to accommodate subsequent shifting of the supporting soil for the manhole 15 and pipe 13.

In a first version of the manhole connector of the invention shown in FIGS. 2-3, the elastomeric gasket 29 is received in snap-fit fashion within a mating groove 31 which is cast in the sidewall opening 25 so that the gasket presents an exposed sealing face on the peripheral surface 27.

Generally, the elastomeric gasket 29 will thick enough to cover about half of the exposed area of the peripheral surface 27 (see FIG. 3A). However, various thicknesses of the elastomeric gasket 29 are suitable so long as a good relatively secure seal is provided between the pipe 13 and the manhole sidewall opening 25. The elastomeric gasket body shown in FIG. 2 has a substantially homogeneous composition and may be made of an elastomeric material such as neoprene, isoprene, or a combination thereof, natural gum rubber, or other rubber-like material resilient in nature. A 55 Durometer natural or synthetic rubber such as a “SBR” commercial grade rubber provides a suitable deformability of the elastomeric gasket body 29, for example.

For the first version of the manhole connector of the invention, the geometry of the elastomeric gasket body 29 can best be appreciated with respect to the cross sectional views presented in FIGS. 2, 3 and 3A of the drawings. The elastomeric gasket body 29 has a leading nose region 33 which is joined to a radially inwardly slanting primary sealing surface 35 which forms a lip seal for engaging an exterior surface of the pipe 13 during insertion. The primary sealing surface 35 is joined to a secondary sealing surface 37 by an intermediate circumferential groove region 39. The secondary sealing surface 37 comprises a planar circumferential region which terminates in an inside corner 41 of the elastomeric body 29. The external gasket surface 43 begins as a uniformly sloping surface at the inside corner 41. After reaching an apex region 45, the sloping surface continues downwardly to rejoin the leading nose region 33.

As shown in FIG. 3, the body of the elastomeric gasket 29 has a length defined between the nose region 33 and the inside corner 41 thereof and has an overall width defined between the outermost wall region apex or pitch point 45 and the lip region innermost extent (generally at 35 in FIG. 3). The overall length is illustrated as “l” in FIG. 3. The overall width is illustrated as “w” in FIG. 3. A relatively rigid reinforcing ring 47 passes through the ring shaped elastomeric body 29 at one circumferential location such that when viewed in cross section appears below the peripheral surface 27 of the wall opening 25, as seen in FIGS. 3 and 3A. By “relatively rigid” is meant that the ring may be formed of a material selected from the group consisting of metals, metal alloys, rigid plastics and composites. Preferably, the ring is formed or a metal such as steel.

By providing a metal ring 47 below the peripheral surface 27, the elastomeric body 29 is made resistant to deformation so that the elastomeric body 29 as a whole is securely maintained on the peripheral surface 27 during the installation of the mating pipe 13. Also, the metal ring 47 helps to retain the elastomeric body 29 in position and insure the elastomeric body 29 is not dislodged or displaced during storage, transportation or field installation once the formation of the manhole 15 is completed. Because the metal ring 47 is encapsulated within the elastomeric body 29, it is entirely isolated from the external environment including water, sewage or other fluids flowing through the pipe joint. As such, the metal ring 47 is not subject to corrosion or deterioration by contact with liquids.

Because the relatively rigid ring 47 is located below the level of the peripheral surface 27, as viewed in FIG. 3, it is necessary to cant and flex the gasket body during the installation process. It is also necessary that the ring location be determined that will allow the gasket to be installed within the groove 31, but which will also be securely retained in its location once the installation operation is complete. Various techniques may be utilized to cant and flex the gasket body so that the larger diameter ring will fit within the relatively smaller diameter wall opening into the sidewalls of the manhole. One device for installing a gasket by canting and flexing the gasket is shown in U.S. Pat. No. 6,044,539, issued Apr. 4, 2000, and assigned to the assignee of the present invention. While the device is used in that case to install a gasket into a mating groove received in the bell end opening of a plastic pipe, such a device could be adapted for use in the present installation.

While FIGS. 2, 3 and 3A illustrate one possible version of the connector gasket of the invention, it is also possible that the gasket will assume a variety of different shapes. For example, FIGS. 4 and 4A illustrate another embodiment of the gasket of the invention in which the gasket body 49 includes a pair of retaining rings 51, 53 which straddle the sidewall opening 25 in the manhole. The rings 51, 53 are preferably encapsulated within the elastomeric material of the gasket body by at least a thin layer of the rubber like material. In this case, the peripheral surface (27 in FIG. 1A) may or may not be provided with a mating groove or depression. The retaining rings 51, 53 may be sufficient for retaining the gasket body in position on the peripheral surface 27, even where no groove or depression is present. Again, the ring location of the rings 51, 53 is below the level of the mouth opening, as viewed in the cross section of FIGS. 4 and 4A once the gasket is snapped in place. As a result, it is necessary to bend and flex at least one of the rings in order to achieve the placement of the gasket body, as viewed in FIG. 4A.

FIG. 5 illustrates another version of the gasket of the invention in which the gasket body 54 includes a third relatively rigid ring 55 located proximate the outer lip of a trailing portion 57 of the gasket body. The trailing portion and additional relatively rigid ring 55 assist in engaging an exterior surface of the mating male pipe 13.

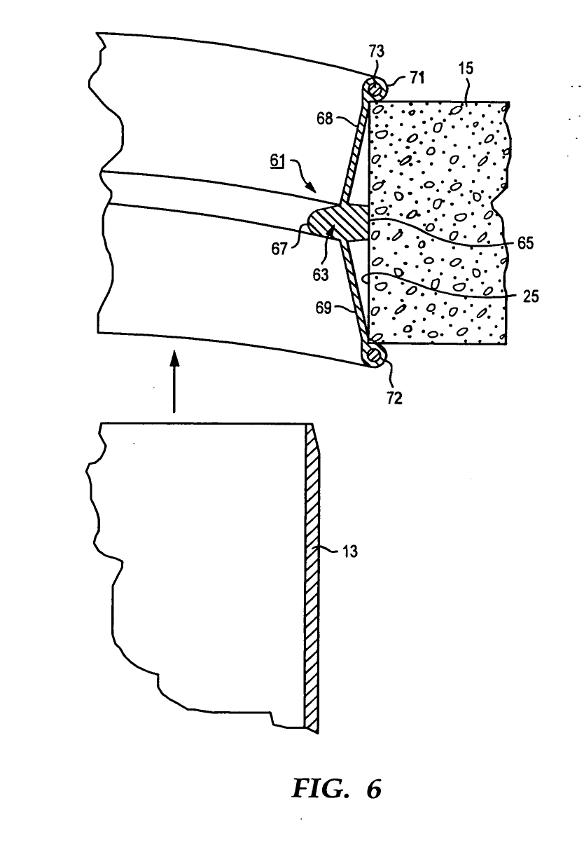

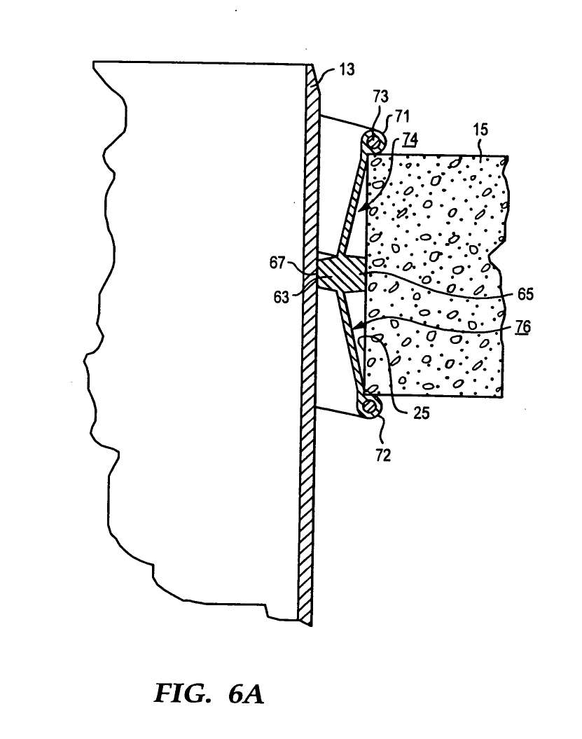

FIG. 6 illustrates another version of the gasket used in the connector system of the invention in which the gasket body 59 includes a central circumferential region 61 with a substantially rectangular cross section 63. The central circumferential region 61 has opposing sealing surfaces 65, 67, one of which 65 seals against the internal diameter 25 of the concrete manhole 15 and, the other of which 67 seals against the external surface of the mating pipe 13. A pair of oppositely extending flap regions 68, 69 extend from the central circumferential region 61. Each of the flap regions 68, 69 terminate in an outer peripheral region 71, 72, each of which contains an encapsulated relatively rigid retaining ring 73. The gasket outer peripheral regions 71, 72 straddle the wall opening 25 in the sidewall of the manhole 15 whereby the gasket 59 is securely retained in a locked-in position with respect to the wall opening 25. The location of the retaining rings 73 appears below the peripheral surface of the wall opening 25 once the gasket 59 is in place.

FIG. 6A is a view similar to FIG. 6, but showing the mating male pipe section being received within the manhole sidewall opening 25. Note that the opposing sealing faces 65, 57 will typically be compressed somewhat and the initial void areas 74, 76 may decrease or disappear as the compression of the gasket takes place through contact with the male pipe end.

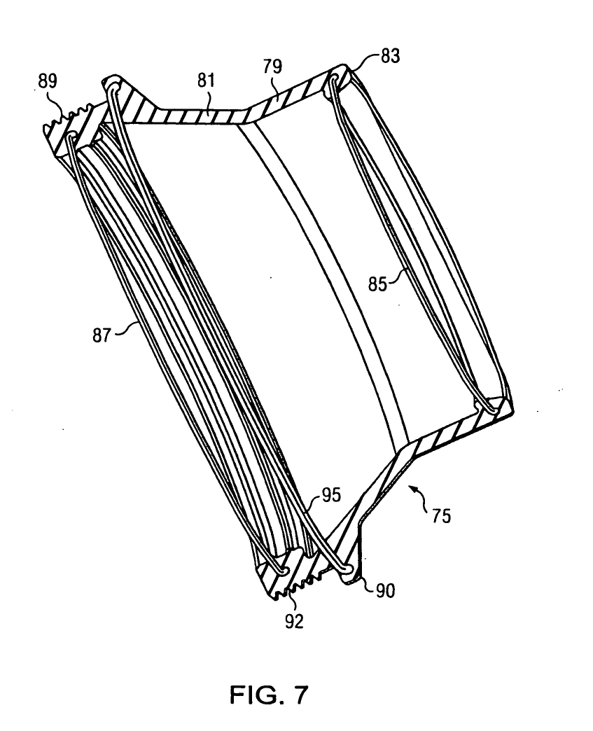

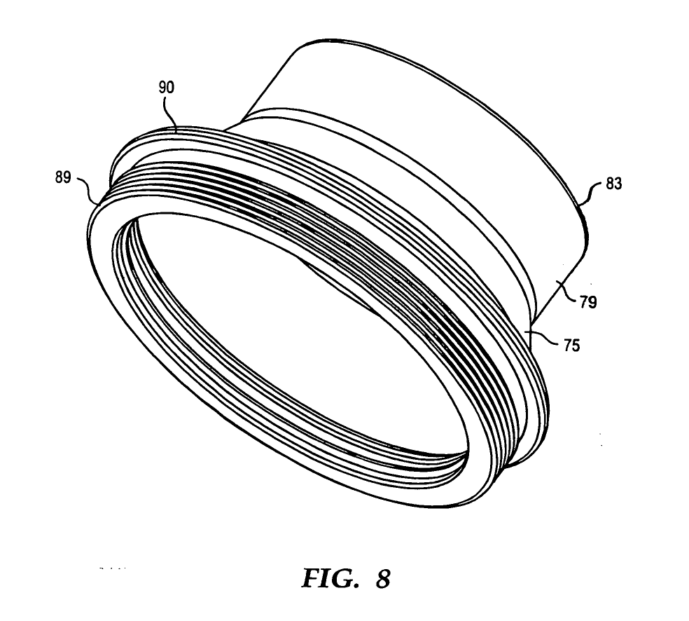

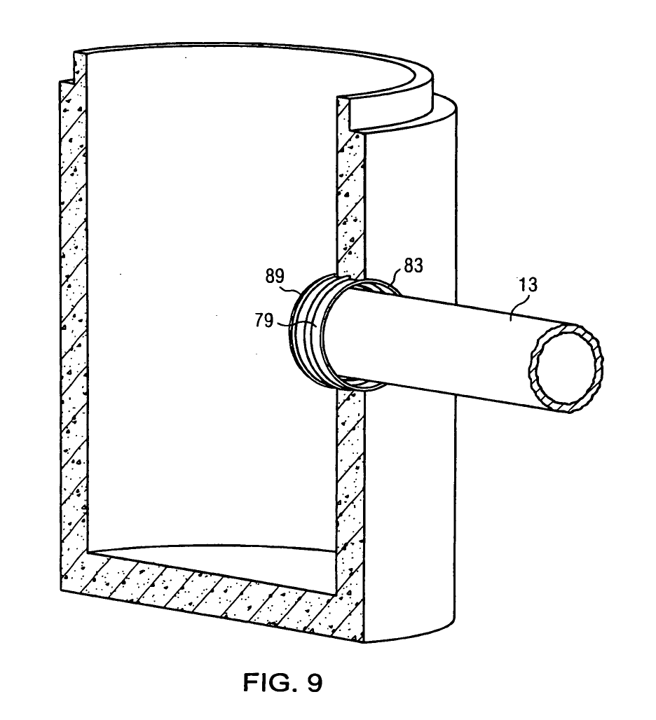

FIG. 7 illustrates another version of the sealing gasket used in the manhole connector system of the invention in which the gasket body 75 is a truncated cone shape with a cylindrical outer portion 79 as viewed with respect to the installed gasket in FIG. 9, a flared base 81 (FIG. 7), and oppositely arranged outer and inner peripheries 83, 89, respectively. A pair of retaining rings 85, 87 circumscribe the connector with the retaining rings 85, 87 being completely encapsulated within the elastomeric gasket body 75. The outer periphery 83 of the cylindrical outer portion 79 contains a first encapsulated relatively rigid retaining ring 85. This encapsulated ring 85 reinforces the outer periphery 83 to form a fluid tight seal between the manhole sidewall opening 25 (see FIG. 1A) and the mating pipe 13 (FIG. 9). The second relatively rigid retaining ring 87 is encapsulated within the inner periphery 89 of the inner flared portion of the base 81 and, in addition to serving a sealing function with respect to the mating male pipe, also helps to ensure that the gasket is securely retained in a locked-in position with respect to the wall opening 25 in the sidewall of the manhole 15. In the version of the sealing gasket shown in FIG. 7, the gasket body 75 also has an external lip region 90 at the base of the truncated region of the body which circumscribes the exterior surface of the body. An additional relatively rigid ring 95 is located on one side of the lower periphery 89 of the flared base 81 in the protruding lip region 90. The additional relatively rigid ring 95 assists in engaging an exterior surface of the mating male pipe 13 and in securely retaining the gasket body 93 within the sidewall opening 25 of the manhole. In the version of the gasket shown in FIG. 7, the inner periphery 89 has a series of external ribs 92 which circumscribe the peripheral surface.

In each of the above cases, the placement of a relatively rigid ring or rings within the gasket body allows the gasket to be obliquely inserted within the wall opening of the manhole and to be subsequently snap-fitted into position either by hand, or with a mechanical tool such as the previously described tool shown in U.S. Pat. No. 6,044,539, issued Apr. 4, 2000, and assigned to the assignee of the present invention, whereby the gasket is securely retained in a locked-in position with respect to the wall opening in the sidewall of the manhole.

An invention has been provided with several advantages. The sealing gasket used in the manhole connection of the invention will not tend to roll and shift as a mating pipe is being inserted within an opening in the manhole. Additionally, the sealing gasket will not be displaced from its sealing position due to a difference of internal or external pressures on either side of the sealing connection. By providing a metal ring below the gasket peripheral surface, the elastomeric body of the gasket is made resistant to deformation so that the elastomeric body as a whole is securely maintained on the peripheral surface of the concrete manhole opening during the installation of the mating pipe, or during storage, transportation or other activities. This combination of structural features insures that the elastomeric body is resistant to deformation so that the elastomeric body as a whole is securely maintained on the peripheral surface of the manhole opening during the installation and subsequent use.

While the invention has been shown in several of its forms, it is not thus limited but is susceptible to various changes and modifications without departing from the spirit thereof.

1. A manhole connector assembly, comprising:
a manhole having generally cylindrical sidewalls, the sidewalls being defined between an outside surface and an inside surface separated by a wall thickness;
a wall opening communicating the outside and inside sidewall surfaces of the manhole for insertion of a mating pipe;
the wall opening defining a peripheral surface relatively perpendicular to the outside and inside sidewall surfaces;
a ring shaped elastomeric gasket having a body formed of rubber retained in position on the peripheral surface of the wall opening in the manhole, the ring shaped elastomeric gasket having a substantially homogeneous composition and having two rigid metal retaining rings encapsulated within the rubber of the gasket body which circumscribe the ring shaped elastomeric gasket at a pair of spaced circumferential locations, the locations of the rigid rings being precisely determined to allow the gasket to be obliquely inserted within the wall opening of the manhole and snap-fit into position, whereby the gasket is securely retained in a locked-in position with respect to the wall opening in the sidewall of the manhole;
wherein the ring shaped elastomeric gasket body is a truncated cone shape with a cylindrical outer portion which gradually increases in external diameter to form a flared base and oppositely arranged outer and inner peripheries, the outer periphery of the outer portion containing a first one of the rigid metal retaining rings and the inner periphery of the flared base containing a second of the rigid metal retaining rings, the retaining rings being completely encapsulated within the elastomeric gasket body, and
wherein the gasket body also has an external lip region at the base of the truncated region of the body which circumscribes an exterior surface of the body and wherein a third rigid metal retaining ring is located in the external lip region, the third rigid metal retaining ring serving to more securely retain the gasket body within the sidewall opening of the manhole.

2-3. (canceled)

4. The assembly of claim 1, wherein the gasket is snap-fit into position by hand.

5. The assembly of claim 1, wherein the gasket is snap-fit into position by means of a mechanical tool which bends the gasket at an oblique angle during insertion.

6-10. (canceled)

11. The assembly of claim 1, wherein the rigid metal retaining ring contained in the inner periphery of the cylindrical outer portion forms a fluid tight seal between the gasket body and the mating pipe.

12. The assembly of claim 1, wherein the rigid metal retaining ring contained in the inner periphery of the flared base serves as a sealing gasket for the opening in the manhole, whereby the gasket is securely retained in a locked-in position with respect to the wall opening in the sidewall of the manhole.

13. The assembly of claim 1, wherein the exterior of the gasket body adjacent the inner periphery thereof has a series of external ribs which circumscribe the inner periphery.
